(19) United States
(12) Patent Application Publication
(10) Pub. No.: US 2013/0163189 A1
(43) Pub. Date: Jun. 27, 2013

(54) Hand-Held Electronic Devices and Related Methods for Improving Thermal Behavior of Such Devices

(71) Applicant: Bogdan Ionut Tudosoiu, Hjarup (SE)

(72) Inventor: Bogdan Ionut Tudosoiu, Hjarup (SE)

(73) Assignee: HTC CORPORATION, Taoyuan City (TW)

(21) Appl. No.: 13/337,444

(22) Filed: Dec. 27, 2011

(51) Int. Cl. G06F 1/20; H02N 2/18

(52) U.S. Cl. 361/679.46; 310/339

(57) ABSTRACT

Hand-held electronic devices and methods for improving thermal behavior of such devices are provided. In this regard, a representative hand-held electronic device includes: a processor operative to execute instructions; a kinetic energy harvester operative to generate electrical power responsive to movement of the hand-held electronic device; and a Peltier component in thermal communication with the processor, the Peltier component being operative to receive power from the kinetic energy harvester and to remove heat from the processor.

### TECHNICAL FIELD

The present disclosure generally relates to portable electronic devices.

### BACKGROUND

Over the years, portable electronic devices (such as smartphones and hand-held gaming devices, for example) have become prevalent. Notably, more modern devices tend to have increased power requirements. Typically, increased power requirements results in increased temperature profiles for the devices that can be detrimental to onboard processors and processor behavior.

In an effort to reduce the temperatures of the processors, efforts have been placed on reducing transmitted power and/or processing speeds. Unfortunately, these efforts tend to have a detrimental effect on the experience of the user.

### SUMMARY

Hand-held electronic devices and methods for improving thermal behavior of such devices are provided. Briefly described, one embodiment, among others, is a hand-held electronic device comprising: a processor operative to execute instructions; a kinetic energy harvester operative to generate electrical power responsive to movement of the hand-held electronic device; and a Peltier component in thermal communication with the processor, the Peltier component being operative to receive power from the kinetic energy harvester and to remove heat from the processor.

Another embodiment is a method for improving thermal behavior of a hand-held electronic device comprising: providing a hand-held electronic device with an onboard processor; and selectively cooling the processor responsive to movement of the device.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram depicting an example embodiment of a hand-held electronic device.

FIG. 2 is an example embodiment of a method for improving thermal behavior of a hand-held electronic device.

FIG. 3 is a partially cut-away, schematic view of another example embodiment of a hand-held electronic device.

FIG. 4 is another example embodiment of a method for improving thermal behavior of a hand-held electronic device.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

Hand-held electronic devices and methods for improving thermal behavior of such devices are provided. In some embodiments, the devices (e.g., smartphones) incorporate onboard processors that generate heat during use, as well as onboard provisioning for converting movement of the device to electrical energy. In some embodiments, the power is used to operate a Peltier component that provides cooling. Notably, the Peltier component can be positioned in thermal communication with the processor. In such a configuration, the Peltier component can remove heat from the processor. For example, during use of the device for playing games, when excess heat is often generated by the processor, the Peltier component can cool the processor by using electricity that is converted from the increased movement of the device that tends to accompany game use.

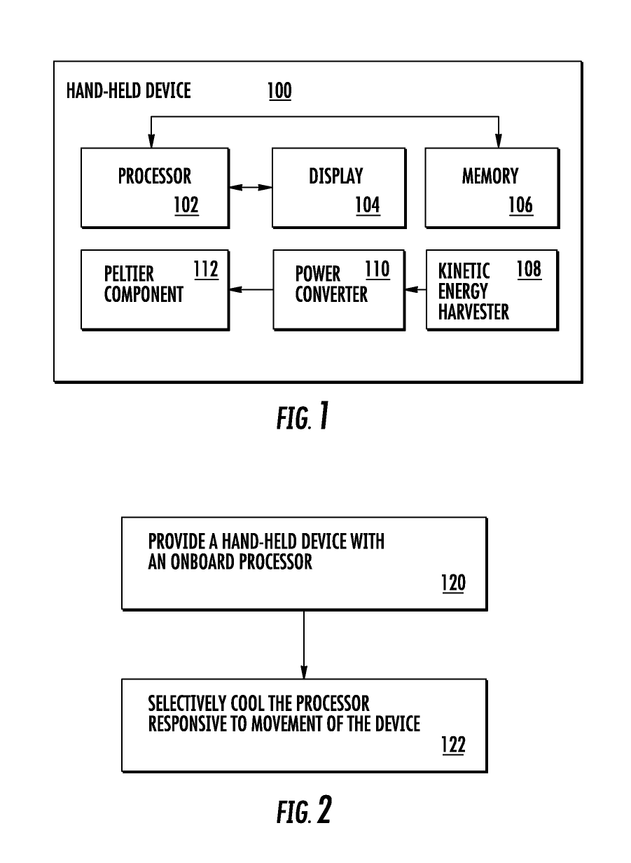

An embodiment of a hand-held electronic device will now be described followed by a discussion of the operation of various components of the system. In this regard, FIG. 1 is a schematic diagram depicting an example embodiment of a hand-held electronic device. As shown in FIG. 1, device 100 incorporates a processor 102, a display 104 and a memory 106. Also included in device 100 is a kinetic energy harvester 108, a power converter 110 and a Peltier component 112. The Peltier component is positioned in thermal communication with the processor, with the cool side of the Peltier component preferably facing the processor.

In operation, the processor performs various functions, such as executing instructions that are stored in memory and which may be associated with applications (e.g., game applications). The processor also drives the display so that information is displayed to the user of the device. Of particular interest is the generation of heat by the processor while performing these functions.

Excess heat from the processor can be extracted by the Peltier component, which receives power from the kinetic energy harvester via the power converter. In this embodiment, the kinetic energy harvester uses the piezoelectric effect to convert mechanical strain into electrical power. Notably, the mechanical strain is associated with movement of the hand-held device, such as may occur during the playing of game applications. In other embodiments, various other types of kinetic energy harvesters can be used, such as those that use micro hydraulics and/or the pyroelectric effect, for example. With respect to the pyroelectric effect, in some embodiments, the heat form the processor itself is used to charge a kinetic harvester. Since the power generated may not be appropriate for direct use by the Peltier component, the power converter can be used to ensure that properly conditioned power is provided to the Peltier component.

FIG. 2 is an example embodiment of a method for improving thermal behavior of a hand-held electronic device. As shown in FIG. 2, the method includes providing a hand-held electronic device with an onboard processor (block 120). In block 122, the processor is selectively cooled responsive to movement of the device.

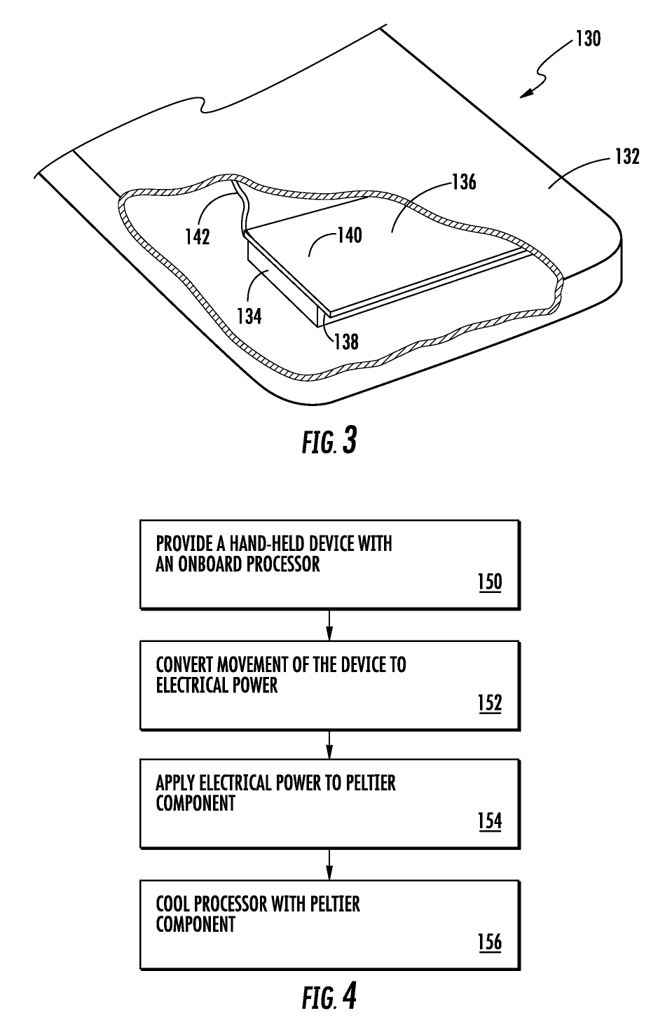

FIG. 3 is a partially cut-away, schematic view of another example embodiment of a hand-held electronic device. As shown in FIG. 3, device 130 is configured as a smartphone, the exterior of which is formed at least in part by a housing 132. Within the housing is mounted a processor 134, a kinetic energy harvester (not shown) and a Peltier component 136. The Peltier component is positioned at least partially between the housing and the processor. The Peltier component also is in thermal communication with the housing such that heat from the Peltier component is dissipated by the housing. In particular, the Peltier component has a cool side 138 and a hot side 140. The cool side is positioned adjacent to (e.g., in direct contact with) the processor. One lead (142) of a set of leads also is shown that provides electrical power to the Peltier component.

FIG. 4 is another example embodiment of a method for improving thermal behavior of a hand-held electronic device. As shown in FIG. 4, the method includes providing a hand-held electronic device with an onboard processor (150). In block 152, movement of the device is converted into electrical power. By way of example, converting of the movement of the device into electrical power can be performed using the piezoelectric effect.

In block 154, the electrical power is provided to a Peltier component. Thereafter, the Peltier component is used to cool the processor by extracting heat from the processor (block 156). In some embodiments, heat from the Peltier component is dissipated with a housing of the device.

It should be emphasized that the above-described embodiments are merely examples of possible implementations. Many variations and modifications may be made to the above-described embodiments without departing from the principles of the present disclosure. By way of example, although the flowcharts show specific orders of execution, it is to be understood that the orders of execution may differ. All such modifications and variations are intended to be included herein within the scope of this disclosure and protected by the following claims.

At least the following is claimed:

1. A hand-held electronic device comprising:
a memory;
a processor operative to execute instructions stored in the memory;
a kinetic energy harvester operative to generate electrical power responsive to movement of the hand-held electronic device; and
a Peltier component in thermal communication with the processor, the Peltier component being operative to receive power from the kinetic energy harvester and to remove heat from the processor.

2. The device of claim 1, further comprising a power converter electrically communicating with the kinetic energy harvester and the Peltier component, the power converter being operative to receive electrical power from the kinetic energy harvester and to condition the power for providing to the Peltier component.

3. The device of claim 1, wherein:
the device further comprises a housing within which the processor, the kinetic energy harvester and the Peltier component are located; and
the Peltier component is positioned at least partially between the housing and the processor.

4. The device of claim 1, wherein the Peltier device is in thermal communication with the housing such that heat from the Peltier component is dissipated by the housing.

5. The device of claim 1, wherein:
the Peltier component has a cool side and a hot side; and
the cool side is positioned adjacent to the processor.

6. The device of claim 5, wherein the cool side of the Peltier component is in direct contact with the processor.

7. The device of claim 1, further comprising a display operative to display images responsive to inputs directed by the processor.

8. The device of claim 1, wherein the device is a smartphone.

9. The device of claim 1, wherein the kinetic energy harvester is operative to convert mechanical strain to electrical power.

10. The device of claim 1, wherein the kinetic energy harvester is operative to convert heat to electrical power.

11. A method for improving thermal behavior of a hand-held electronic device comprising:
providing a hand-held electronic device with an onboard processor; and
selectively cooling the processor responsive to movement of the device.

12. The method of claim 11, wherein selectively cooling further comprises converting movement of the device into electrical power.

13. The method of claim 12, wherein converting movement of the device into electrical power is performed using the piezoelectric effect.

14. The method of claim 12, wherein selectively cooling further comprises:
applying the electrical power to a Peltier component; and
cooling the processor with the Peltier component.

15. The method of claim 14, further comprising dissipating heat from the Peltier component with a housing of the device.

16. The method of claim 14, further comprising directly contacting the processor with a cool side of the Peltier component.

17. The method of claim 11, wherein selectively cooling further comprises converting heat of the device into electrical power.

18. The method of claim 17, wherein at least a portion of the heat converted into electrical power is provided by the processor.

19. The method of claim 12, wherein selectively cooling further comprises using the electrical power to cool the processor.

20. The method of claim 19, wherein using the electrical power to cool the processor further comprises powering a component to provide a cool surface for extracting heat from the processor.
